(19) United States
(12) Patent Application Publication
(10) Pub. No.: US 2026/0104126 A1
(43) Pub. Date: Apr. 16, 2026

(54) SUPPRESSION DEVICE FOR USE WITH PIPE TAPPING

(71) Applicant: Brett Joseph Trout, Indianapolis, IN (US)

(72) Inventors: Brett Joseph Trout, Indianapolis, IN (US); Gage Wilkinson, Terre Haute, IN (US)

(21) Appl. No.: 19/355,474

(22) Filed: Oct. 10, 2025

Related U.S. Application Data
(60) Provisional application No. 63/706,269, filed on Oct. 11, 2024.

(51) Int. Cl. F16L 57/00; F16L 41/04

(52) U.S. Cl. CPC F16L 57/00; F16L 41/04

(57) ABSTRACT

A suppression device and methodology for suppressing and controlling an explosion to protect objects or persons near to an explosion site. The suppression device can include a heavy-duty product made of a heavy-duty material that can suppress and control an explosion such as during a tapping procedure. The suppression device can be configured to lay over the outer of and around at least a portion of a pipe and tap assembly after the tap assembly (for example, a tapping saddle and corporation) are installed. The suppression device can be secured by a plurality of fasteners to the pipe and tap assembly such that the device absorbs a blast and contains any flying chards of razor sharp plastic, they preventing a tapper from being impaled or struck causing injury or even death.

### CROSS-REFERENCE TO RELATED APPLICATION

This application claims priority to and the benefit of provisional U.S. Patent Application No. 63/706,269, filed October 11, 2024, which is hereby incorporated herein by reference in its entirety.

### FIELD OF THE DISCLOSURE

The disclosure relates generally to a device and method for suppressing an explosion and, more particularly, a device and method for suppressing an explosion of a pipe or vessel containing pressurized fluid, such as, for example, during tapping, to prevent debris and pressurized fluid from spreading and impacting nearby objects and people.

### BACKGROUND OF THE DISCLOSURE

In industrial systems that transport pressurized fluids such as oil, gas, chemicals, or steam, tapping operations are often required to create access points for maintenance, monitoring, or expansion without interrupting service. These operations, particularly hot tapping, involve modifying or penetrating a live pressurized pipeline. While this technique offers operational efficiency, it introduces significant safety risks, most notably the potential for pipe rupture or explosion.

Explosions during tapping can result from any combination of factors, including excessive internal pressure that exceeds a pipe’s structural limits, thermal stress from cutting operations, or material fatigue that weakens the pipe wall. Such failures can lead to uncontrolled release of substances, equipment damage, and serious injury or loss of life. The risk is particularly acute in aging infrastructure or systems operating under extreme conditions. To address these challenges, several mitigation strategies have been developed, such as pre-tap integrity assessments, including ultrasonic testing and radiographic inspection, to evaluate wall thickness and detect flaws, specialized tapping sleeves and fittings designed to distribute stress and contain pressure during the operation, pressure relief and isolation systems that temporarily reduce internal pressure or isolate the tapping zone, and real-time monitoring technologies, such as thermal sensors and acoustic emission detectors, to detect abnormal conditions during tapping.

Despite these advancements, existing solutions often lack adaptability to varying pipe dimensions, pressure regimes, and fluid types. There remains a need for improved systems and methods that enhance safety, reliability, and operational control during tapping of pressurized pipelines.

### SUMMARY OF THE DISCLOSURE

The instant disclosure provides an effective, efficient, and inexpensive solution for protecting objects and people within the vicinity of a pipe tapping site. The solution includes one or more embodiments of a device and methodology for suppressing and controlling an explosion such as during pipe tapping.

According to an aspect of the disclosure, a suppression device is provided for controllably suppressing an exploding pipe during pipe tapping. The suppression device comprises a body that is configured to surround a pipe and a tap assembly in situ, wherein the body includes a collar and an opening. The suppression device can include one or more fasteners configured to securely fasten the suppression device to the pipe and tap assembly. The fastener(s) can include any combination of one or more of hook-and-loop fasteners, buckles, straps, pins, clips, bolts, U-bolts, eye bots, screws, nuts, or the like.

In various embodiments of the suppression device, the body includes a plurality of layers of materials configured to withstand a violent explosion of a pipe carrying highly pressurized fluid, such as, for example, a pipe or a vessel made of polyvinyl chloride (PVC) commonly used in industry. The body is configured to suppress and control the explosion by confining exploding debris (for example, pieces of the pipe or tap assembly) and pressurized fluid to an area between pipe and the body, and preventing the debris and pressurized fluid from traveling past the body where it might otherwise impact an object or person.

In at least one embodiment of the suppression device, the body comprises at least three layers, including a pair of outer layers and an inner active layer sandwiched therebetween. The outer layers can include a shell material that is resistant to ambient conditions and can shield the inner active layer(s). The outer layers can include a material such as, for example, nylon, vinyl, or the like, and active layer can include a high-strength synthetic material such as aramid fibers (for example, Kevlar^{®}),

In various embodiments, a suppression device is provided for use during pipe tapping operations, wherein the device includes: a body having an inner layer, at least one core layer, and an outer layer, the body being configured to wrap around a pipe and a tapping assembly; at least one collar having an opening and a collar reinforcement band configured to receive a portion of the tapping assembly; a plurality of fasteners configured to secure the body around a pipe and a tapping assembly; and reinforcement webbing having a plurality of reinforcement members positioned longitudinally on the body. The inner layer and the outer layer can be configured, formed, or affixed to each other to form a shell enclosure. The one or more core layers can be enclosed within the shell enclosure and configured to remain loose within the enclosure to absorb and dissipate energy from an explosive event. The inner layer of the body can have a perimeter affixed to a perimeter of the outer layer of the body to form the shell enclosure.

The reinforcement webbing can be attached to, and/or integrated with, the outer layer of the body.

The reinforcement webbing can have a plurality of reinforcement members positioned longitudinally on the body. The reinforcement webbing can include a second plurality of reinforcement members positioned at an angle with respect to the first plurality of reinforcement members. The angle can be anywhere between, for example, 0° and 180°, preferably about 90°. In at least one embodiment, the reinforcement members comprise a strap.

In certain embodiments, the suppression device can have a body that includes a slit, which can extend from an edge of the body to the collar opening. The suppression device can further include a cover layer configured to cover the slit during use and expose the slit during installation of the suppression device.

In some embodiments, the suppression device has a body that includes a fault indicator configured to indicate exposure of the suppression device to an explosion event. The inner layer of the body can include the fault indicator.

In various other embodiments, a suppression device is provided for use during pipe tapping operations, wherein the device includes: a body having an inner layer, at least one core layer, and an outer layer, the body being configured to wrap around a pipe and a tapping assembly; and at least one collar having an opening configured to receive a portion of the tapping assembly. The collar can include a collar reinforcement band that surrounds at least a portion of the opening. The inner layer and the outer layer of the body can form a shell enclosure. At least one core layer can be loosely contained within the shell enclosure and configured to absorb and dissipate energy from an explosive event. The suppression device can include a plurality of fasteners configured to secure the body around the pipe and the tapping assembly. The device can include reinforcement webbing attached to, or integrated with, the outer layer of the body. The reinforcement webbing can include a plurality of reinforcement members positioned longitudinally on the body. The suppression device can include an optional slit extending from an edge of the body to the collar opening, and a cover layer configured to cover the slit during use and expose the slit during installation of the suppression device. The suppression device can include an optional fault indicator configured to indicate exposure of the suppression device to an explosion event.

The suppression reinforcement webbing can include a second plurality of reinforcement members positioned an angle with respect to said plurality of reinforcement members. The angle cam be approximately 90°. The reinforcement members can include one or more straps.

Additional features, advantages, and embodiments of the disclosure may be set forth or apparent from consideration of the following detailed description, drawings, and claims. Moreover, it is to be understood that both the foregoing summary of the disclosure and the following detailed description are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced.

FIG. 1 shows an example of a pipe with a tapping mechanism.

FIG. 2A shows an embodiment of a suppression device.

FIG. 2B shows another embodiment of a suppression device.

FIG. 3 shows an exploded view of an embodiment of a suppression body for a suppression device.

FIGS. 4-8 and 12-15 shows various other embodiments of the suppression device, constructed according to the principles of the disclosure.

FIGS. 9-11 show various other embodiments of the suppression device with a pipe, according to the principles of the disclosure.

FIG. 16 shows a cut-away view of an embodiment of the suppression device, cut along a line A-A in FIG. 15.

The present disclosure is further described in the detailed description and drawings that follows.

### DETAILED DESCRIPTION OF THE DISCLOSURE

The embodiments of the disclosure and the various features and advantageous details thereof are explained more fully with reference to the non-limiting embodiments and examples that are described or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated. Descriptions of well-known components and processing techniques can be omitted so as to not unnecessarily obscure the embodiments of the disclosure. The examples are intended merely to facilitate an understanding of ways in which the disclosure can be practiced and to further enable those of skill in the art to practice the embodiments of the disclosure. Accordingly, the examples and embodiments should not be construed as limiting the scope of the disclosure, which is defined solely by the appended claims and applicable law. Moreover, it is noted that like reference numerals represent similar parts throughout the several views of the drawings.

The inventor has discovered a critical and unmet need for a solution to mitigate injuries and property damage resulting from the explosive failure of pipes and vessels during tapping operations. In the United States alone, hundreds of thousands of main taps are performed each year on conduits, including plastic piping systems such as polyvinyl chloride (PVC) water mains. A significant number of these procedures result in serious injuries or fatalities due to sudden pipe ruptures. These hazardous events can occur due to the different behavior of, for example, air compared to water when escaping through a small opening, such as the forming hole of a tap. Due to its lower density and compressibility, air can rush out rapidly, leaving behind a temporary void. Water, being incompressible, quickly moves to fill this space. As it does, it gains significant momentum. When this fast-moving water encounters a physical barrier—like the pipe wall—it cannot compress or dissipate easily, resulting in a sudden and forceful impact. This phenomenon, known as water hammer, generates a sharp spike in pressure. These transient pressure surges can exceed 1000 PSI (pounds-per-square-inch). This is sufficient to rupture a pipe not designed to withstand such extremes and cause the pipe to fracture explosively, propelling sharp PVC fragments at high velocities. These fragments have been documented to travel distances exceeding 100 yards, posing a lethal threat to personnel within a 10-foot radius of the tap site. The present disclosure provides a suppression device and associated methodology designed to contain and control such explosive events, thereby significantly reducing the risk of injury to nearby individuals and minimizing collateral damage to surrounding equipment and infrastructure.

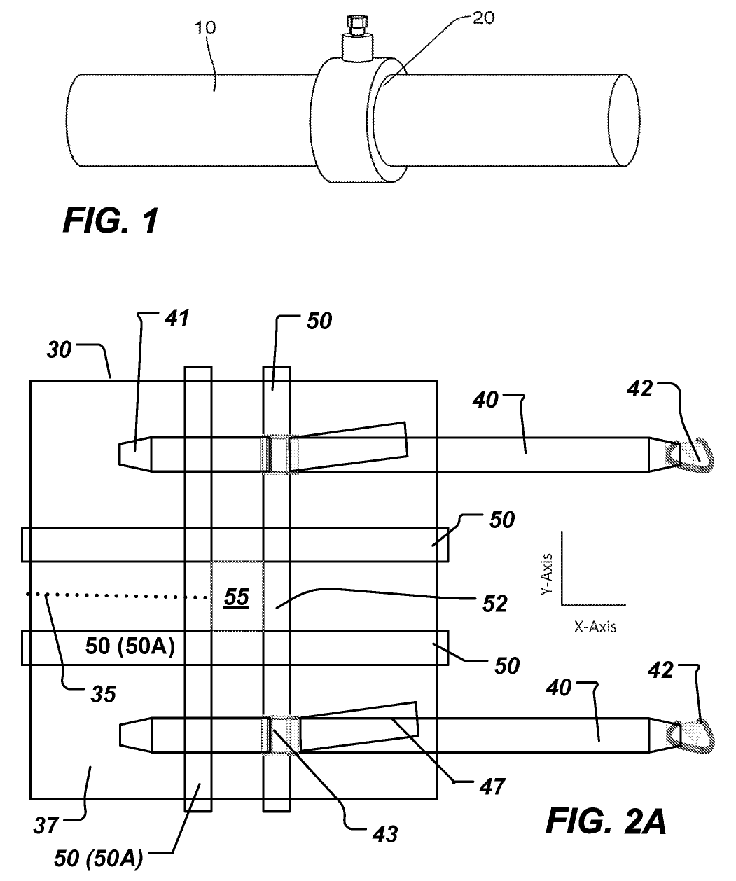

FIG. 1 shows a nonlimiting example of an application for the disclosed solution. In this example, a PVC pipe main 10 is tapped by means of a tapping assembly 20 positioned in a desired location for a tap. Other applications for the solution are contemplated herein, including other types of conduits, including conduits made of different materials that might be susceptible to failure during tapping procedures.

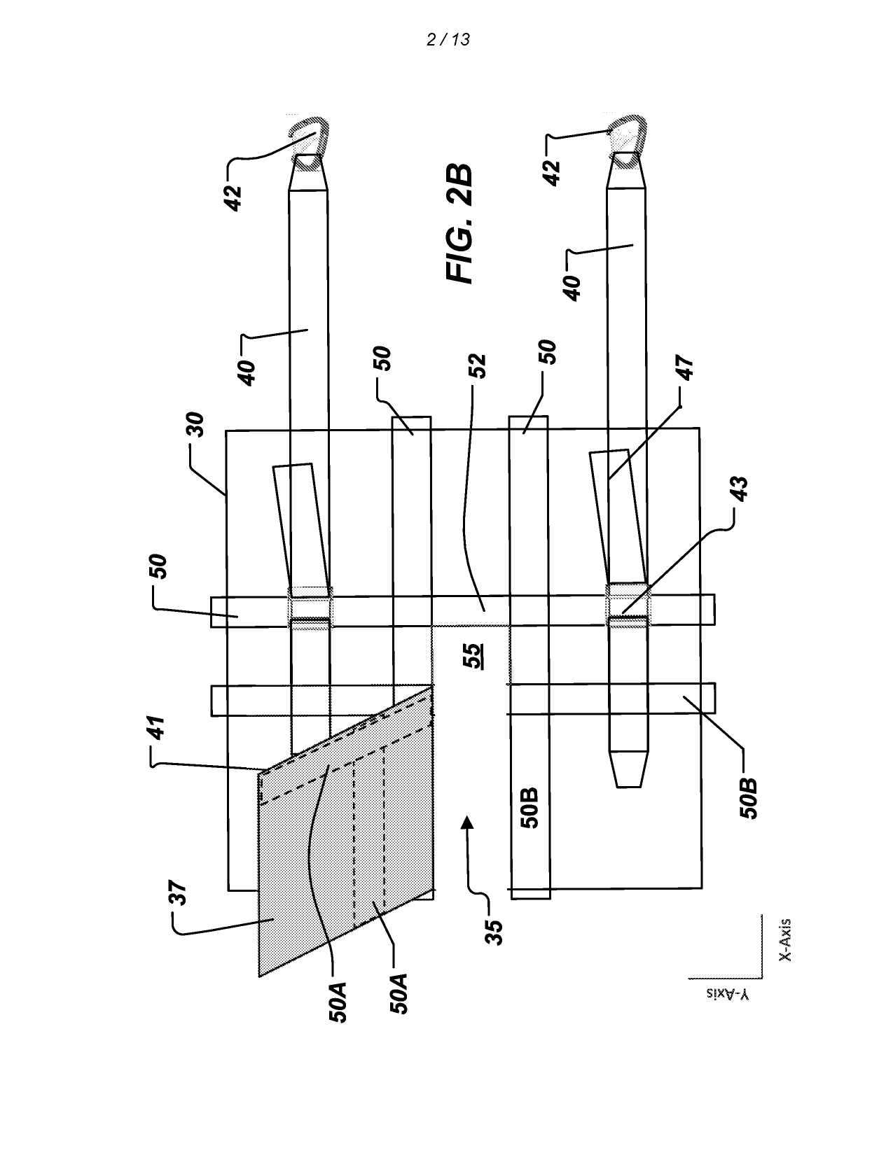

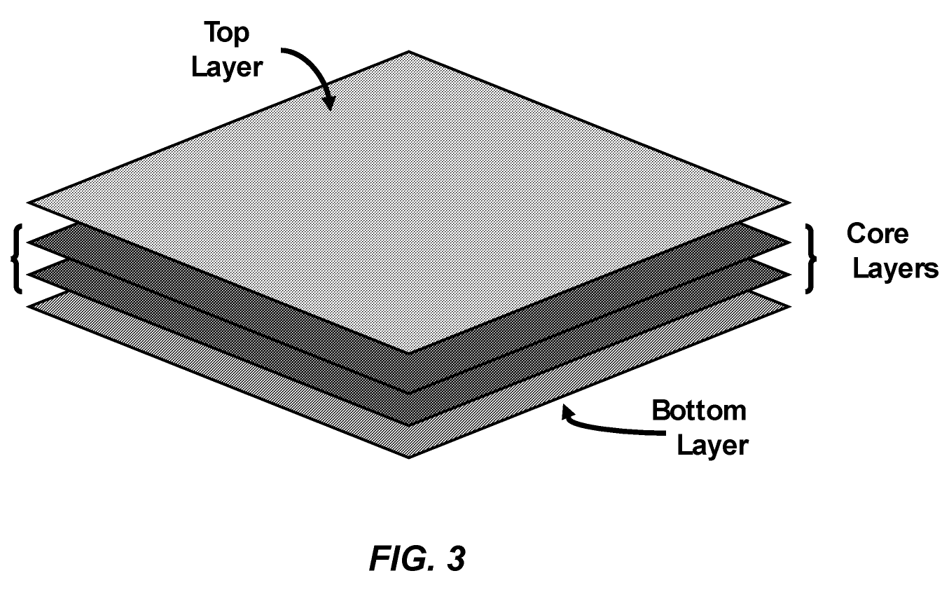

FIG. 2A shows an embodiment of a suppression device constructed according to the principles of the disclosure. The suppression device is designed and constructed such that it can be installed on-site (in situ)and wrapped around the pipe 10 and the tap assembly 20, including, for example, a tapping saddle. The suppression device includes a main body 30, a plurality of fasteners 40, and a collar 52 having an opening 55 configured to allow a connecting portion of the tap assembly 20 to pass therethrough such that it can protrude above a surface of the body 30. The suppression device can include reinforcement webbing 50, which, in various embodiments, can be affixed to or integrally formed with the main body 30. The collar 52 can include a collar reinforcement band around its entire perimeter, as seen in FIG. 2A. The collar reinforcement band can include one or more layers of reinforcement webbing 50. In various embodiments, the collar reinforcement band can have any shape, including a circle, a semi-circle, a square, an ellipse, or a rectangle.

In some embodiments, the main body 30 can include an optional slit 35 that, for example, provides an opening along a length from an edge of the main body 30 to the opening 55, thereby making it easy to install and remove the suppression device from the pipe 10 with tapping assembly 20.

FIG. 2B shows an embodiment of a suppression device with a main body 30 having a slit 35 formed along a direction parallel to an edge of one side of the main body 30 (for example, x-direction). As seen, the slit 35 forms an opening or cut-out from an edge of the main body 30 to the opening 55 to facilitate installation by sliding the suppression device on to the tapping assembly 20 and around the tap, without requiring vertical (or any other direction) clearance to lift it over the tap. In this embodiment, the main body 30 includes a cover layer 37 to cover the slit 35. The cover layer 37 can be affixed to (or form) the outer layer of the main body 30.

In an embodiment, the cover layer 37 includes a flap that can be pulled to one side when installing the suppression device and replaced to cover the slit 35 during use. In this regard, the collar reinforcement band (for example, made of one or more layers of reinforcement webbing 50) that forms one side of the collar 52 can be attached to the cover layer 37 (as depicted by the broken lines in FIG. 2B) such that it moves with the cover layer 37 to uncover the slit 35 during installation and cover the slit 35 during use. The cover 37 can include supplemental reinforcement webbing 50A (as depicted by the broken lines in FIG. 2B) that can be positioned on the cover 37 such that when the cover is closed, the reinforcement webbing 50A overlaps the reinforcement webbing 50B. The cover 37, which can be configured to overlap the outer layer of the main body 30, can be positioned, together with at least one fastener 40, such that the cover 37 is positioned beneath the fastener(s) 40 to hold the slit 35 closed in the event of an explosion. The embodiments of the suppression device configured with a slit 35 and cover 37 allow for removal of the suppression device, even after a branching pipe has been installed at the newly tapped location—this can be especially helpful where the user forgets to remove the suppression device before connecting the new pipe to the new tap.

In the embodiments comprising the slit 35, the outer and inner layers of the main body 30 can be attached to each other along both sides of the slit 35 and the inner perimeter of the opening 55. In at least one embodiment, the outer and inner layers of the main body 30 can also be attached along the outer perimeter, along the edges of the main body 30, to form a shell enclosure to encapsulate and hold the core layers therein. According to one analogy, in various embodiments, the shell enclosure can be constructed similar to a pillowcase configured to contain a pillow. Carrying this analogy further, the core layers are akin to the pillow, which can remain “loose” and simply rest loosely in the pillowcase (i.e., the shell enclosure). This method allows the suppression device to easily revert to its original form after being crumpled or “beaten up”, but the core layers can still flex and stretch to absorb energy even though the fabric cannot roll into itself within the pillowcase.

FIG. 3 shows an embodiment of a main body 30 for a suppression device, constructed according to the principles of the disclosure. In this embodiment, the main body 30 includes a outer (or top) layer, an inner (or bottom) layer, and at least two core layers sandwiched between the outer and inner layers. The outer and inner layers can include vinyl-coated polyester and/or neoprene-coated nylon, and the core layers can include one or more 1000D Cordura nylon layers. The outer and inner layers can be formed and affixed to each other to form a shell enclosure that holds and encapsulates the core layers.

In other embodiments, the main body 30 can consist of a single layer, a pair of layers, or three or more layers. The main body 30 is made of at least one layer that is weather-resistant, water impermeable, and suitable for prolonged use under harsh environmental conditions.

In various embodiments, the main body 30 has an outer and/or inner layer made of one or more materials, including any combination of, for example, vinyl-coated polyester, neoprene-coated nylon, TPU-coated fabrics (thermoplastic polyurethane), silicone-coated fiberglass, CSM-coated fabrics (chlorosulfonated polyethylene), PTFE-coated fabrics (polytetrafluoroethylene), urethane-coated nylon, urethane-coated polyester, PVC-free coated polyester, EPDM-coated Fabrics (ethylene-propylene-diene-monomer), aramids, aromatic polyamides, synthetic fibers made from poly-paraphenylene terephthalamide (e.g., Kevlar^{®}), 400D DWR coated nylon fabric, and tent-weight DWR coated ripstop nylon (70D).

In certain embodiments, the outer layer is made the same as the inner layer. In other embodiments, the outer layer is made different from the inner layer.

In various embodiments, the inner layer, which is closest to the pipe 10, can be made of material that is a higher wearing material or even a lighter weight material than that of the outer layer. The inner layer is constructed to withstand routine strapping and unstrapping. In at least one embodiment, the inner layer includes a fault indicator, which is configured to visibly indicate exposure of the main body 30 and/or inner to an explosion event. The fault indicator can facilitate notifying an operator that the suppression device has already undergone one or more explosion events, to prevent use of a damaged, or otherwise unsuitable, suppression device that may be susceptible to failure during use. The fault indicator can include a material that notifies an operator of wear, long before unsafe amounts of wear have accumulated, that has made the suppression device susceptible to failure. The fault indicator can include a color, a texture, or other visible attribute of the inner layer, or another part, of the main body 30 that indicates damage or exposure to an explosion event.

In various embodiments, the main body 30 has one or more core layers made of one or more materials, including any combination of 1000D Cordura^{®} nylon, 1000 denier nylon, 1000D Cordura nylon, 1680 bullet nylon, Dyneema, aramids, aromatic polyamides, synthetic fibers made from poly-paraphenylene terephthalamide, 3000D Kevlar^{®}, 1050D ballistic nylon, Cordura^{®} HP, Cordura^{®} EcoMade, polyester 1680D, polyester 1800D, X-Pac™ laminates, ripstop nylon (e.g., 70D–420D), Twaron^{®}, Spectra^{®}, Zylon^{®} (PBO), Vectran^{®}, carbon fiber fabrics, and basalt fibers. The material(s) can be selected based on properties such as, for example, strength, weight, durability, and abrasion resistance. In certain embodiments, one or more core layers can be constructed to be loose within a shell envelope formed by the outer and inner layers, which can be especially effective for stopping ballistic shrapnel.

In at least one embodiment, the main body 30 comprises a shell envelope formed by the outer and inner layers being fastened to each via stitching around the tapping hole(s) 55. The core layers are sandwiched between the outer and inner layers, but are otherwise unrestrained, leaving the core layers almost entirely loose within the shell envelope. The design of this embodiment makes it easy to manufacture the main body 30 and, resultantly, the suppression device.

In various embodiments, the main body 30 includes a shell envelope formed by fastening the edges of the outer layer to edges of the inner layer along the perimeters of the outer and inner layers. The main body 30 can include one or more additional fastening points, segments, or lines across the width and length of the main body 30. The core layers are enveloped in the shell such that, except for the shell envelope and any fastening points, segments, or lines, the core layers remain unrestrained and loose such that, when impacted by debris from an exploding pipe, the core layers dissipate the energy of the moving debris while preventing penetration of the debris.

Referring to FIG. 2, the suppression device can have any number of fasteners 40, depending on the particular application. Any one or more of the fasteners 40 can be adjustable and/or removable from the main body 30. Each fastener 40 can have a first end 41 and a second end 42, either or both of which can include a connector member, including, for example, a carabiner, snap hook, swivel hook, D-ring, O-ring, Chicago screw, snap, rivet, bolt, nut, U-bolts, eye bots, one-wrap strap, buckles, side-release buckle, cam buckle, ladder lock buckle, G-hook, tri-glide slide, hook-and-loop (for example, Velcro^{®}), straps, pins, clips, self-weighted (pellets/fake sand inside), or other fastening mechanism that facilities easy and quick coupling and decoupling of the first and second ends 41/42 to each other or to another connector member (not shown).

In various embodiments, the fasteners 40 are made of one or more materials, including any combination of, for example, UV-resistant polypropylene webbing (such as, for example, 2" with >1,470 lb. breaking strength), polyester webbing, nylon webbing (UV-treated or solution-dyed), Dyneema^{®} (UHMWPE) webbing, Spectra^{®} (UHMWPE) webbing, aramid webbing (e.g., Kevlar^{®}, Twaron^{®}) webbing, and high-density polyethylene (HDPE) webbing. Any one or more of the fasteners 40 can be made stronger by folding the fastener onto itself one or more times to form multiple layers that can then be sewn together or otherwise attached to each other to form a single structure that makes the fastener 40. In at least one embodiment the fastener 40 includes a strong (>1,470 lb. breaking strength) strap that can have an adjustable length by means of a fastener adjustment device 43, which can include, for example, a load-rated (>1,470 lb. breaking strength) buckle, cam buckle, steel ratchet buckle, turnbuckle, or quick-release load-rated buckle.

In various embodiments, the fastener 40 can be made by folding a strap and overlaying a first section of the strap over and onto the other, second section of the strap. The length of the first section can be longer than the length of the section. In an embodiment, the sections can be made to have the same length. The first end 41 of the fastener 40 can be formed by folding an edge portion of an end of the first section onto itself and sewing the parts together to form an eye or opening that can receive (or that includes, before sewing) a connector. The second end 42 of the fastener can be formed by sewing a portion of the first and second sections near the fold but leaving a portion at the fold unattached to form an eye that can receive (or that includes, before sewing) a connector. The fastener adjustment device 43 can be installed on either or both the first and second sections of the strap and configured to adjust an overlength of the fastener 40 by, for example, pulling on a free end 47 of the fastener 40.

The reinforcement webbing 50 can be made of the same material as, or a different material than, the fasteners 40. In various embodiments, the reinforcement webbing 50 includes a plurality of reinforcement members positioned along one or more directions in the plane of the main body 30 (for example, x-y plane, shown in FIGS. 2A, 2B), including, for example a plurality of reinforcement members in a first direction that is, for example, substantially parallel to an edge, along one side, of the main body 30 (for example, along the x-axis) and/or a plurality of reinforcement members in a second direction that is, for example, substantially parallel to another edge, along another side, of the main body 30 (for example, along the y-axis), which can be perpendicular to the first direction or at an angle different from 90° (for example, an angle between 0° and 90° or between 90° and 180°). The reinforcement member can include, for example, one or more straps, which can be overlapped for added strength. For example, the reinforcement webbing 50 can be made stronger by folding a strap onto itself one or more times to form multiple layers that can then be sewn together or otherwise attached to each other to form a reinforcement member having, for practical purposes, a single structure with multifold load strength of the strap.

In certain embodiments, the fasteners 40 (or ends 42) are removable and adjustable and the reinforcement webbing 50 is secured and attached to the main body 30. In some embodiments, the reinforcement webbing 50 is attached to an outer surface of the outer layer of the main body 30 by means of an adhesive or welding. In other embodiments, the reinforcement webbing 50 is attached to the outer layer of the main body 30 by means of stitching, rivets, or similar attachment mechanisms. In other embodiments, the reinforcement webbing 50 can be integrally formed with the main body 30.

In certain embodiments, the reinforcement webbing 50 can include one or more layers of nylon webbing (UV-stabilized), polyester webbing, aramid fiber webbing (e.g., Kevlar^{®}), UHMWPE webbing (e.g., Dyneema^{®}, Spectra^{®}), PVC-coated polyester webbing, or PVC-coated nylon webbing.

The suppression device can be made as a heavy-duty product, made of a heavy-duty material, such as Kevlar^{®}, that is used as a safety shield during the tapping procedures. The suppression device is configured to lay over the outer and around the pipe 10 and tap assembly 20 (shown in FIG. 1) after the tap assembly (for example, tapping saddle) is installed. The suppression device is then secured to the pipe 10 via the fasteners 40. The suppression device is configured to controllably suppress an exploding pipe such as the pipe main 10 during pipe tapping and block any debris or fluids from travelling past the suppression device, instead, containing the debris and fluids between the pipe 10 and the inner layer of the suppression device. The suppression device comprises a body that is configured to surround the pipe and tap assembly in situ. The device is designed for easy use and can be expanded in wrapping dimension by a length of, for example, on the order of a few inches, or more.

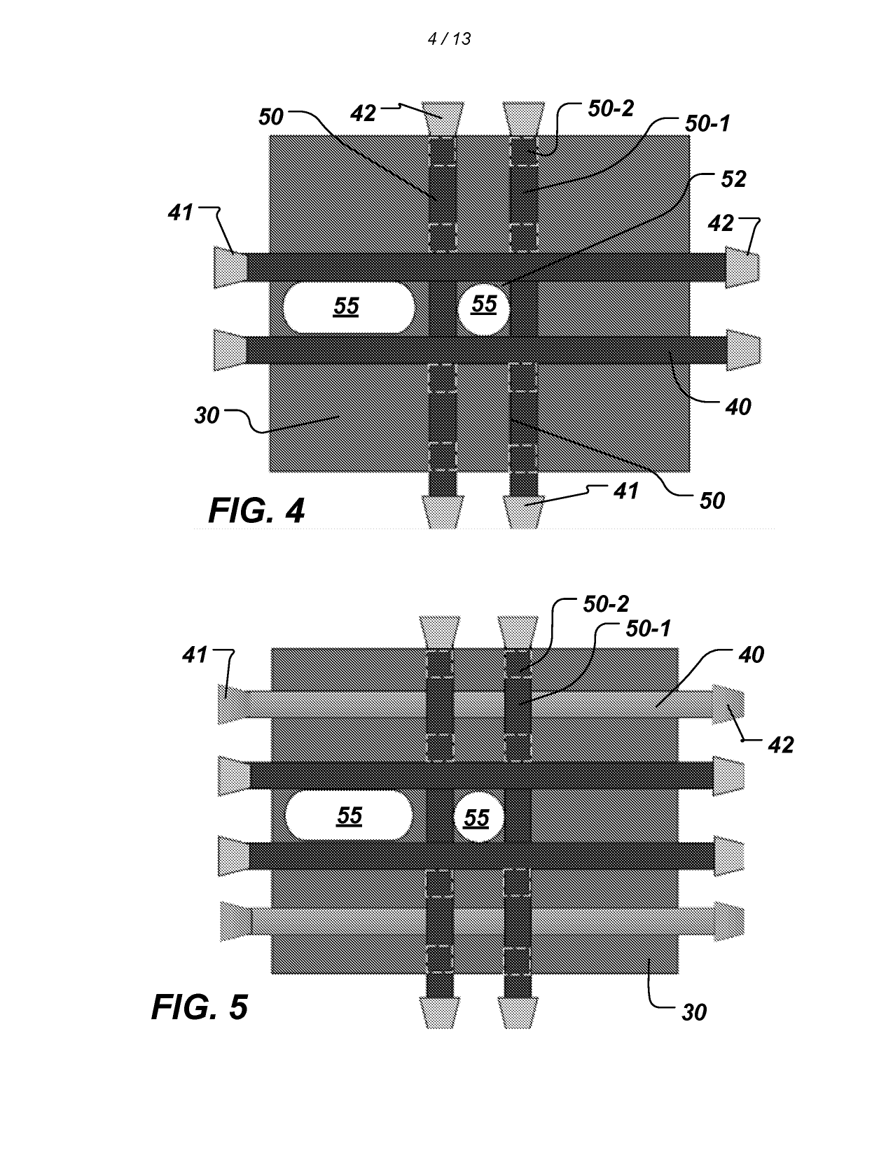

FIGS. 4-8 and 12-15 show various nonlimiting embodiments of a suppression device constructed according to the principles of the disclosure. In various embodiments of each suppression device of FIGS. 4-8 or 12-15, the main body 30 can include the optional slit 35 (shown in FIG. 2B) and cover layer 37 (shown in FIG. 2B), and/or additional (or fewer) fasteners 40, fastener adjustment devices 40, reinforcement webbing 50, collars 52, or openings 55.

FIG. 4 shows an embodiment of a suppression device with a slotted configuration in which the reinforcement webbings 50 include one or more open sections 50-1 and one or more attached section 50-2. The opening section 50-1 can be constructed to have an opening width greater than a width of the fastener 40, such that the fastener 40 can freely slide in the opening section 50-1. Each attached section 50-2 can be affixed securely to (or integrated with) the outer layer of the main body 30. In this embodiment, the main body 30 is configured with two openings 55, at least one of which includes the collar reinforcement band 52. As seen, the larger opening can include a partial collar reinforcement band (for example, reinforcement webbing provided around three sides of the opening 55). The opening 55 is configured to allow a portion of the tapping assembly 20 to pass through the opening and the collar reinforcement band 52 is configured to surround the tap of the tapping assembly 20. The second opening 55 can be configured to facilitate use of the suppression device with smaller diameter pipes 10, or for applications in which it is desirable to wrap the suppression device multiple times around the pipe 10 and tap assembly 20, with the larger opening 55 receiving the tap on a second wrap of the suppression device around the pipe 10, thereby facilitating a tighter and/or more secure wrapping around the pipe 10 with tapping assembly 20.

The partial collar reinforcement band surrounding a portion of the larger opening 55 can be configured to provide additional strength and reinforcement to the collar reinforcement band 52 when the main body 30 is wrapped around the pipe 10 and tapping assembly 20 two or more times with the main body 30 overlapping itself. The larger opening 55 is dimensioned to allow for use with different diameters of pipe 10 and/or ease of wrapping around the saddled pipe 10.

FIG. 5 shows the suppression device of FIG. 4 equipped with a pair of auxiliary fasteners 40 for added strength.

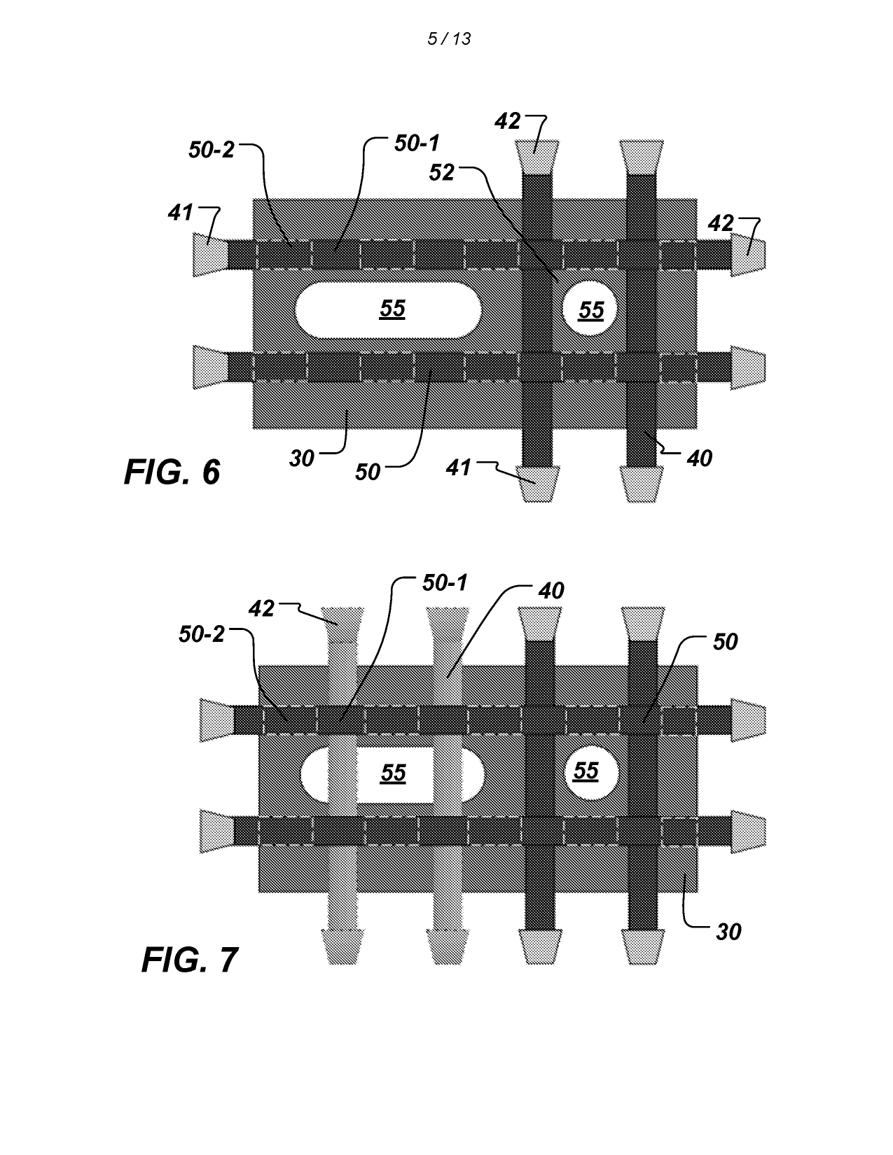

FIGS. 6 and 7 show another embodiment of a suppression device with a slotted configuration, with FIG. 7 also showing auxiliary fasteners 40 for added strength.

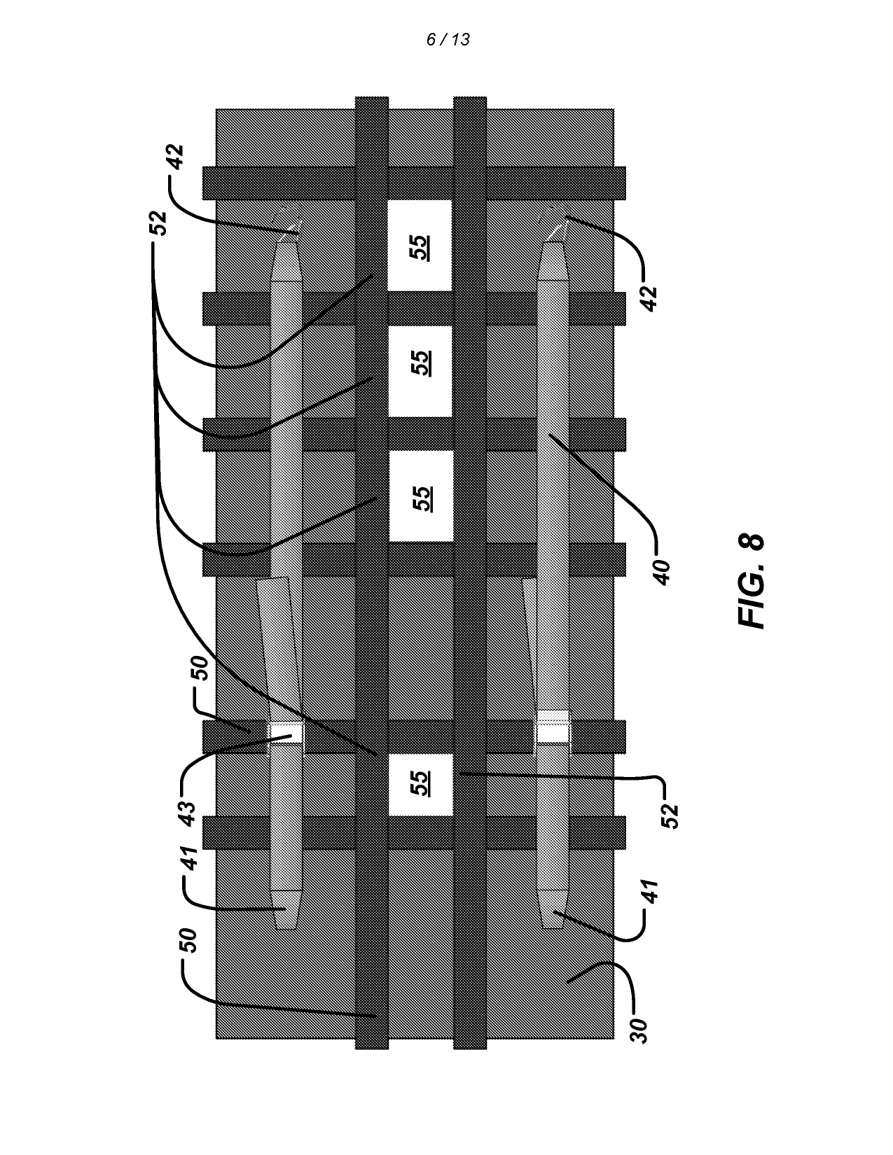

FIG. 8 shows yet a further embodiment of a suppression device with a slotted configuration.

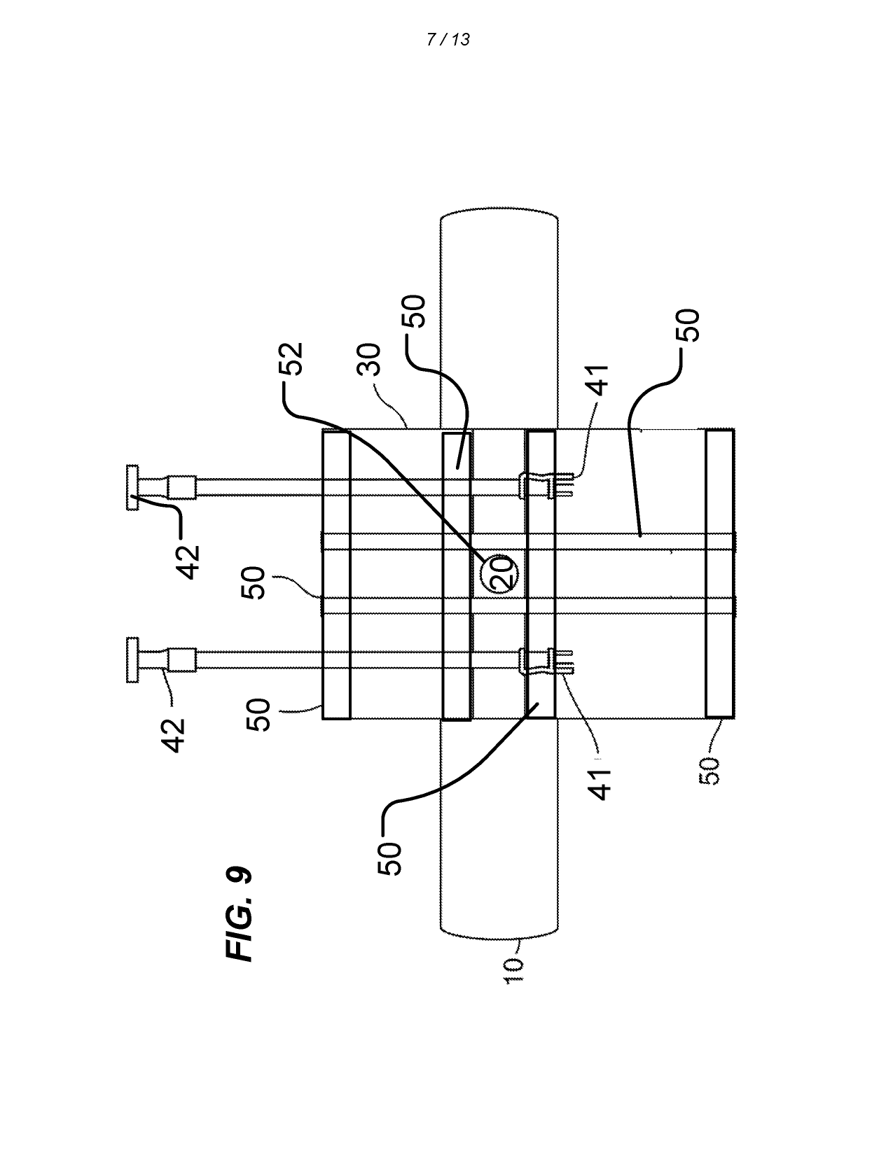

FIG. 9 shows an embodiment of a suppression device that includes additional reinforcement webbing 50 along opposite edges of the main body 30. The additional webbing 50 can include, for example, a hook-and-loop fastener to attach the additional webbing 50 to each other or another section of the main body 30 when wrapped around the pipe 10.

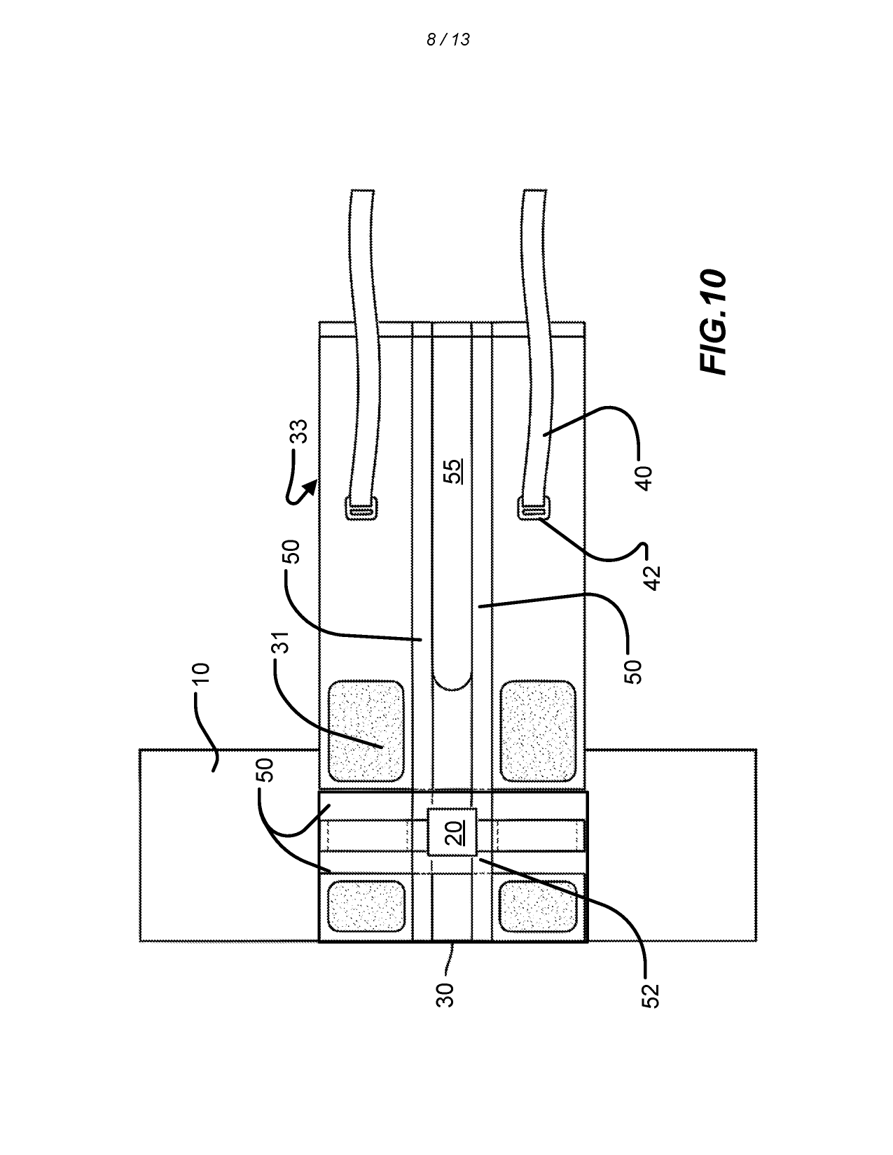

FIG. 10 shows a still further embodiment of a suppression device. In this embodiment, the surface of the outer layer of the outer layer of the main body 30 includes fastener sections 31, which can include, for example, hook-and-loop fasteners. The main body 30 can include additional fastener sections 33 (not shown) on the surface of the inner layer of the main body 30, which can include, for example, hook-and-loop fasteners.

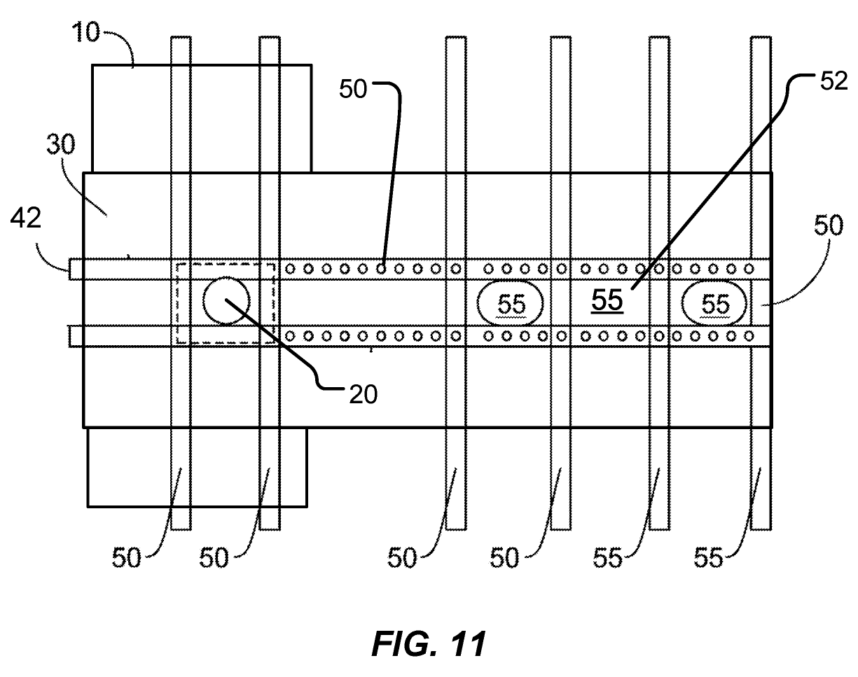

FIG. 11 shows a still further embodiment of a suppression device with a slotted configuration. In this embodiment, a pair of reinforcement webbings 50 can be affixed to the main body 30 along most a length of the main body 30.

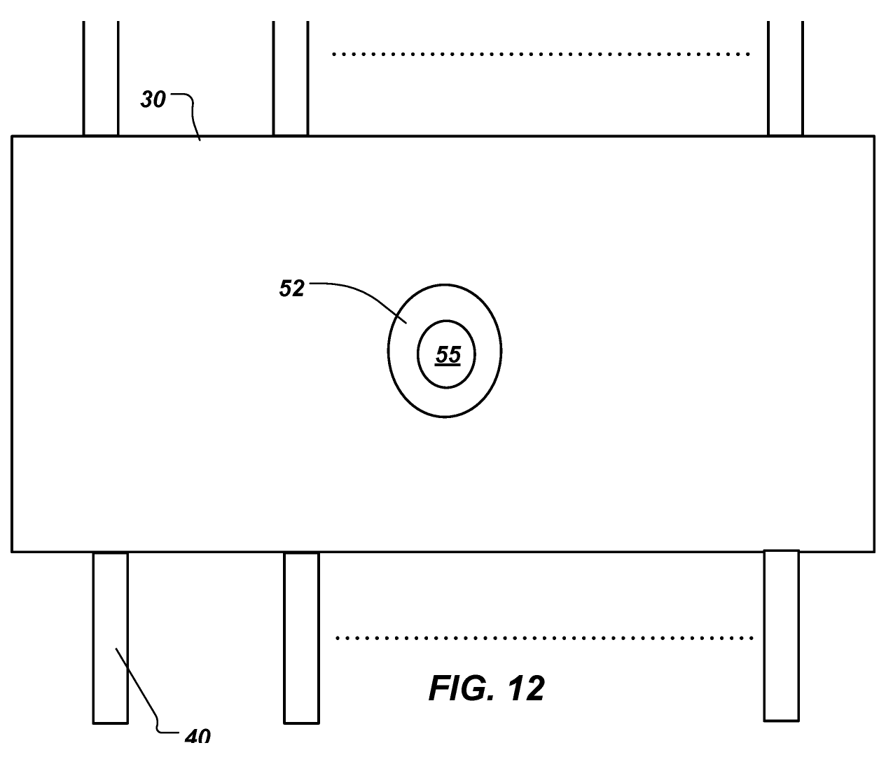

FIG. 12 shows an inner view of a still further embodiment of a suppression device. In this embodiment, the suppression device can be configured with any number of fasteners 40 and/or webbing 50. The depicted surface of the inner layer of the main body 30 can include a fault indicator that provides a visible indication when the integrity or functionality of the main body 30 is compromised and potentially dangerous to use further.

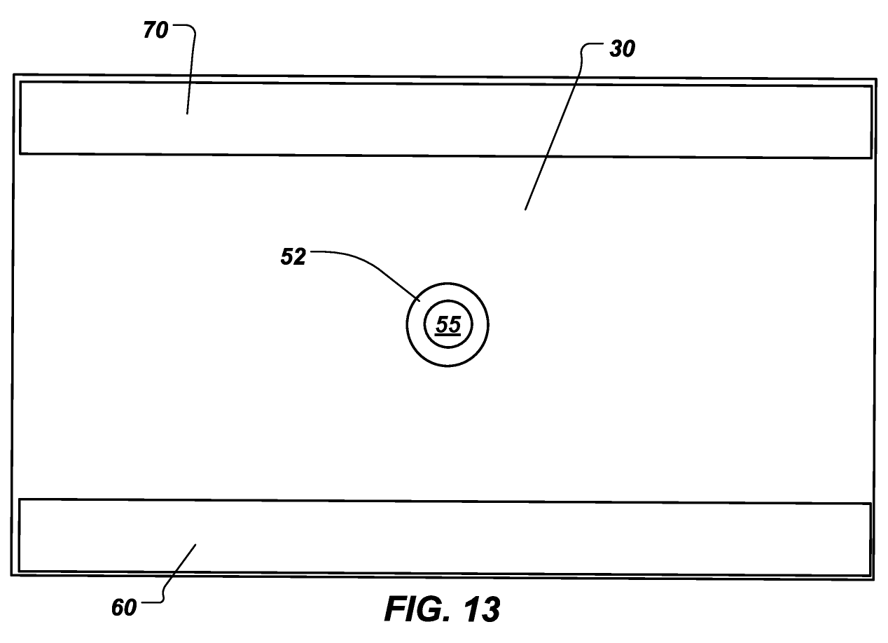

FIG. 13 shows another embodiment of a suppression device. In this embodiment, the main body 30 can be equipped with a plurality of fastener regions 60, 70 that are configured to mate to each other. For instance, the fastener region 60 can include a hook portion and the fastener region 70 can include a loop portion such that the portions connect and securely engage each other to fasten the main body 30 around a pipe 10 and tap assembly 20 (shown in FIG. 1).

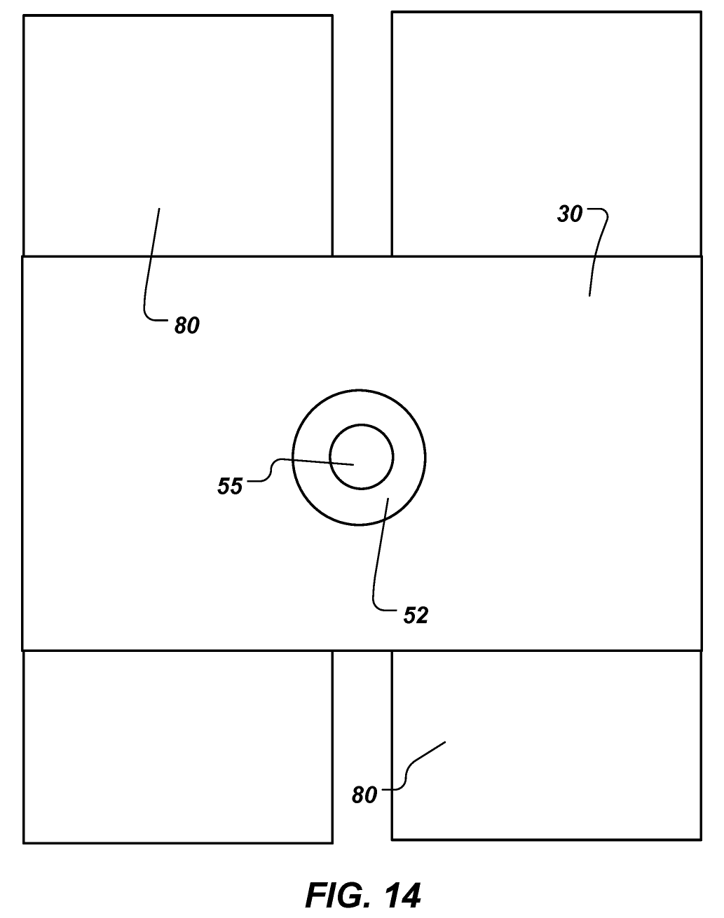

FIG. 14 shows a further embodiment of a suppression device. In at least one embodiment, the suppression device can include one or more body extensions 80. The body extensions 80 can be made of the same material as the main body 30 or one or more layers of the main body 30. The body extensions 80 can be separated by a distance that is substantially equal to or greater than a width of the tapping saddle to facilitate wrapping the body extensions 80 one or more times around the full diameter of the pipe 10 for added security and explosion suppression/control.

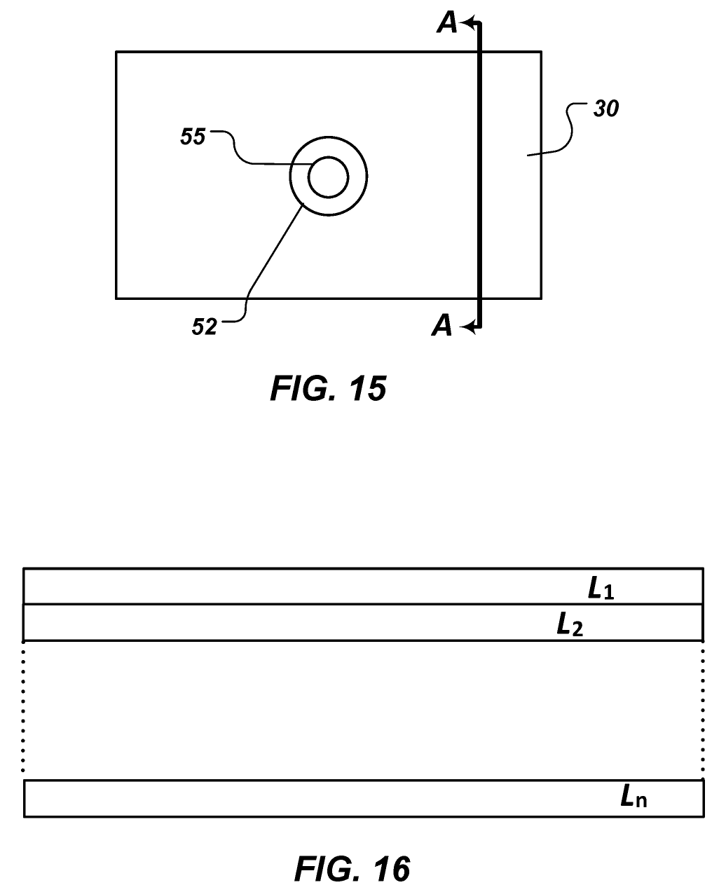

FIG. 15 shows an inner view of another embodiment of a suppression device, with the surface of the inner layer of the main body visible.

FIG. 16 shows a cross-section view of the suppression device in FIG. 15 cut along a line A-A (shown in FIG. 15). As seen, the suppression device can include n layers L (where n is a positive integer). In various embodiments, the suppression device can include one, two, three, four, five, six, or more layers L, with at least one of the layers being configured to withstand a violent explosion of a pipe carrying highly pressurized fluid, such as, for example, a pipe made of polyvinyl chloride (PVC) commonly used in industry. The main body 30, including the layers L 1 , L 2 , … L n , is configured to suppress and control the explosion by confining exploding debris (for example, pieces of the pipe or tap assembly) and pressurized fluid to an area between the pipe 10 and the inner layer of the main body 30, preventing the debris and pressurized fluid from traveling past the main body 30 where it might otherwise impact an object or person.

The suppression device constructed according to the principles of the disclosure can be used in a variety of applications for mitigating risks relating to explosion of pipes or other vessels. To install the suppression device, the operator first positions the tapping assembly (e.g., a tapping saddle) onto the pipe at the desired location. Once the tap assembly is secured, the suppression device is wrapped around the pipe and the tap assembly. If the device includes an optional slit and cover layer, the operator can slide the device laterally around the tap without needing to lift it over the assembly, simplifying installation in confined spaces. The collar of the device is aligned so that the opening surrounds the protruding portion of the tap assembly, ensuring a snug fit.

The fasteners, such as, for example, straps with buckles, hook-and-loop closures, or carabiners, are then used to secure the suppression device tightly around the pipe. These fasteners may be adjustable or removable, allowing the device to accommodate various pipe diameters and tap configurations. Reinforcement webbing integrated into or attached to the outer layer of the device provides additional structural integrity and helps distribute forces in the event of an explosion.

Once installed, the suppression device acts as a containment shield during the tapping operation. If a sudden pipe rupture occurs—such as from the release of compressed air or fluid—the device is designed to absorb and dissipate the energy, preventing debris and high-pressure fluid from escaping beyond the immediate area. The inner layer, which may include a fault indicator, helps identify whether the device has been compromised during use, ensuring safety for subsequent operations.

The terms “a,” “an,” and “the,” as used in this disclosure, means “one or more,” unless expressly specified otherwise.

The terms “including,” “comprising,” and variations thereof, as used in this disclosure, mean “including, but not limited to,” unless expressly specified otherwise.

Although process steps, method steps, or the like, may be described in a sequential order, such processes and methods can be configured to work in alternate orders. In other words, any sequence or order of steps that may be described does not necessarily indicate a requirement that the steps be performed in that order. The steps of the processes or methods described herein can be performed in any order practical. Further, some steps can be performed simultaneously.

When a single structure or article is described herein, it will be readily apparent that more than one device or article may be used in place of a single device or article. Similarly, where more than one device or article is described herein, it will be readily apparent that a single structure or article may be used in place of the more than one structure or article. The functionality or the features of a structure or article may be alternatively embodied by one or more other structures or articles that are not explicitly described as having such functionality or feature.

While the disclosure has been described in terms of exemplary embodiments, those skilled in the art will recognize that the disclosure can be practiced with modifications in the spirit and scope of the instant disclosure. These examples given above are merely illustrative and are not meant to be an exhaustive list of all possible designs, embodiments, applications or modifications of the disclosure.

What is claimed is:

1. (Original) A suppression device for use during pipe tapping operations, the device comprising:
a body having an inner layer, at least one core layer, and an outer layer, the body being configured to wrap around a pipe and a tapping assembly;
at least one collar having an opening and a collar reinforcement band configured to receive a portion of the tapping assembly;
a plurality of fasteners configured to secure the body around a pipe and a tapping assembly; and
reinforcement webbing having a plurality of reinforcement members positioned longitudinally on the main body,
wherein:
the inner layer and the outer layer form a shell enclosure; and
the at least one core layer is loosely enclosed within the shell enclosure and configured to absorb and dissipate energy from an explosive event.

2. (Original) The suppression device in claim 1, wherein the inner layer has a perimeter affixed to a perimeter of the outer layer to form the shell enclosure.

3. (Original) The suppression device in claim 1, wherein the reinforcement webbing is attached to the outer layer.

4. (Original) The suppression device in claim 1, wherein the reinforcement webbing is integrated with the outer layer.

5. (Cancelled)

6. (Original) The suppression device in claim 4, wherein the reinforcement webbing comprises a second plurality of reinforcement members positioned at an angle with respect to said plurality of reinforcement members.

7. (Original) The suppression device in claim 6, wherein the angle is about 90°.

8. (Cancelled)

9. (Cancelled)

10. (Cancelled)

11. (Cancelled)

12. (Original) A suppression device for use during pipe tapping operations, the device comprising:
a body having an inner layer, at least one core layer, and an outer layer, the body being configured to wrap around a pipe and a tapping assembly; and
at least one collar having an opening configured to receive a portion of the tapping assembly,
wherein:
the collar includes a collar reinforcement band that surrounds at least a portion of the opening;
the inner layer and the outer layer form a shell enclosure; and
the at least one core layer is loosely enclosed within the shell enclosure and configured to absorb and dissipate energy from an explosive event.

13. (Original) The suppression device in claim 12, the device further comprising:a plurality of fasteners configured to secure the body around the pipe and the tapping assembly.

14. (Original) The suppression device in claim 12, the device further comprising:reinforcement webbing attached to, or integrated with, the outer layer.

15. (Original) The suppression device in claim 14, wherein the reinforcement webbing includes a plurality of reinforcement members positioned longitudinally on the body.

16. (Original) The suppression device in claim 15, wherein the reinforcement webbing includes a second plurality of reinforcement members positioned at an angle with respect to said plurality of reinforcement members.

17. (Original) The suppression device in claim 16, wherein the angle is about 90°.

18. (Cancelled)

19. (Cancelled)

20. (Cancelled)
